(19) United States
(12) Patent Application Publication
(10) Pub. No.: US 2025/0260767 A1
(43) Pub. Date: Aug. 14, 2025

(54) SYSTEM AND METHOD FOR OPTIMIZING OUTBOUND COMMUNICATION

(71) Applicant: Assertion, Inc., Middletown, DE (US)

(72) Inventors: Srinivasan NARAYANAN, Pune (IN); Satyam LAD, Pune (IN)

(73) Assignee: Assertion, Inc., Middletown, DE (US)

(21) Appl. No.: 19/052,701

(22) Filed: Feb. 13, 2025

(30) Foreign Application Priority Data
Feb. 13, 2024 (IN) 202411009796

(51) Int. Cl. H04M 3/432

(52) U.S. Cl. CPC H04M 3/432; H04M 2203/6081

(57) ABSTRACT

A system and a method for optimizing outbound communication are described. The system receives the authorization request from one or more first computing devices and sends a communication message to one or more second computing devices, the communication message comprising options for the user to select a preferred time to communicate with the enterprise. The system receives a response from the user, the response comprising consent for receiving communication and the preferred time for receiving the communication. The system provides the response to the one or more first computing devices to schedule and initiate the communication based on the received consent and the preferred time. The system dynamically adjusts the options for the user based on the recorded consent and the preferred time for a predetermined period for continuous user engagement.

### TECHNICAL FIELD

The present disclosure relates, in general, to communication optimization a system and a method, and more specifically, to address the optimization of outbound communication processes in enterprise environments.

### BACKGROUND

In the enterprise-user communication landscape, optimizing outbound calls has emerged as a critical concern, with businesses striving to establish effective and meaningful connections with their user base. This heightened focus is particularly underscored by the prevalent challenges posed by call identification mechanisms, which have become a pervasive hindrance to seamless communication. Despite users willingly consenting to receiving calls at the initiation of services, the widespread use of call identification applications poses a significant challenge. Such applications often misclassify authentic calls initiated by enterprises, flagging them as “spam likely” or “scam likely.” Consequently, users demonstrate a decreased inclination to respond to such calls, resulting in a notable reduction in the overall efficacy of outbound communication strategies.

The identification predicament not only diminishes the success rate of outbound calls but also profoundly influences the overall user experience. Branding legitimate enterprise-initiated calls as potential spam makes users reluctant to engage with such communications, creating a tangible barrier to achieving seamless and effective communication between businesses and their user base. As enterprises endeavour to deliver timely information, updates, and personalized services through outbound calls, the impediment imposed by call identification challenges undermines the very objectives of providing a positive user experience.

Additionally, when users wish to receive calls but face limitations due to busy schedules, there is a lack of a seamless solution connecting enterprises to the users at their preferred time. The absence of such a solution emphasizes the necessity for effective approaches that not only tackle issues related to call identification but also enable optimized communication customized to the user's preferences and availability.

There is, therefore, a need to provide a system and method for optimizing the answer rate of outbound communication.

### OBJECTS OF THE PRESENT DISCLOSURE

A general object of the present disclosure is to enhance answer rate of enterprise-initiated outbound communication with users.

An object of the present disclosure is to receive user consent and preferred time to communicate with user.

An object of the present disclosure is to efficiently manage authorization requests from computing devices associated with enterprises, ensuring proper communication initiation.

An object of the present disclosure is to increase the likelihood of user engagement by scheduling and initiating outbound communication based on the received consent and preferred time of the users.

### SUMMARY

Aspect of the present disclosure relates to communication optimization a system and a method, and more specifically, to address the optimization of outbound communication processes in enterprise environments.

In one aspect of the present disclosure relates to a system for optimizing outbound communication is disclosed. The system includes one or more first computing devices associated with an enterprise, configured to initiate an authorization request for initiating communication with a user. The system also includes one or more second computing devices associated with the user, configured to receive the communication from the one or more first computing devices. A server is communicatively coupled to the one or more second computing devices and includes one or more processors coupled to a memory storing instructions executable by the one or more processors. Herein, the server is configured to receive the authorization request from the one or more first computing devices. The server sends a communication message to the one or more second computing devices, the communication message including options for the user to select a preferred time to communicate with the enterprise. The server receives a response from the user, the response including consent for receiving communication from the enterprise and the preferred time for receiving the communication. The server provides the response to the one or more first computing devices to schedule and initiate the communication from the enterprise based on the received consent and the preferred time. The server dynamically adjusts the options for the user based on the recorded consent and the preferred time for a predetermined period for continuous user engagement.

In one embodiment, the server is configured to maintain a repository of trusted entities and utilize the repository to validate authorization requests prior to sending the communication message to the second computing device.

In one embodiment, the server is configured to determine the user's subscription status to validate active engagement with the enterprise before sending the communication message.

In one embodiment, the options include any or a combination of a specific callback time, an allowed delay in the communication, and an option for declining the communication.

In one embodiment, the server is configured to integrate with an enterprise customer relationship management (CRM) system to record and process the preferences of the user for scheduling the communication.

In one embodiment, the server is configured to dynamically adjust the timing and frequency associated with the communication based on historical patterns of user engagement and response behavior recorded for the predetermined period

In one embodiment, the server is configured to analyze user behavior and optimize the timing of communication using one or more machine learning models.

In one embodiment, the communication message includes at least one of: a rich communication services (RCS), a built-in messaging service associated with the second computing device, a third-party messaging service associated with the second computing device, or an enterprise application installed on the second computing device.

In one embodiment, the server is configured to transmit user consent data to the first computing device for initiating the communication.

In another aspect of the present disclosure relates to a method for optimizing the answer rate of outbound communication is disclosed. The method includes receiving, by a server, an authorization request from a first computing device associated with an enterprise, wherein the authorization request is for initiating communication with a user. The method includes sending, by the server, a communication message to a second computing device associated with the user, the communication message including options for the user to select a preferred time to communicate with the enterprise. The method includes receiving, by the server, a response from the user, the response including consent for receiving communication from the enterprise and the preferred time for receiving the communication. The method includes providing, by the server, the response to the first computing device to schedule and initiate the communication from the enterprise based on the received consent and the preferred time. The method includes dynamically adjusting the options for the user based on the recorded consent and the preferred time for a predetermined period for continuous user engagement

Various objects, features, aspects, and advantages of the inventive subject matter will become more apparent from the following detailed description of preferred embodiments, along with the accompanying drawing figures in which like numerals represent like components . . . .

### BRIEF DESCRIPTION OF THE DRAWINGS

The following drawings form part of the present specification and are included to further illustrate aspects of the present disclosure. The disclosure may be better understood by reference to the drawings in combination with the detailed description of the specific embodiments presented herein.

FIG. 1 shows an exemplary block diagram of a system (100), in accordance with an embodiment of the present disclosure.

FIG. 2 shows an example block diagram of a server (106), in accordance with an embodiment of the present disclosure.

FIG. 3 illustrates a flow chart of an exemplary method (300), in accordance with an embodiment of the present disclosure.

FIG. 4 illustrates an exemplary computer system (400), in accordance with an embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments. On the contrary, the intention is to cover all modifications, equivalents, and alternatives falling within the spirit and scope of the present disclosure as defined by the appended claims.

In the following description, numerous specific details are set forth in order to provide a thorough understanding of the embodiments of the present invention. It will be apparent to one skilled in the art that embodiments of the present invention may be practiced without some of such specific details. Embodiments of this disclosure relate to the field of network security and, more specifically, relate to a system and method to detect intrusion and access of confidential information by unauthorized users in a network.

If the specification states a component or feature “may,” “can,” “could,” or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

As used in the description herein and throughout the claims that follow, the meaning of “user” may refer to “user device,” “one or more second computing devices,” and “second computing device”, unless the context clearly dictates otherwise.

As used in the description herein and throughout the claims that follow, the meaning of “entity” may refer to “enterprise,” “entity device,” “enterprise device,” “one or more first computing devices,” and “first computing device”, unless the context clearly dictates otherwise.

In the enterprise-user communication landscape, optimizing outbound calls has become a significant challenge due to the prevalence of call identification mechanisms that often misclassify legitimate business calls as “spam likely” or “scam likely.” The misclassification leads to a decreased likelihood of users answering such calls, thereby reducing the effectiveness of outbound communication strategies. Additionally, users may have busy schedules, making it difficult for enterprises to connect with them at a convenient time. There is a lack of a seamless solution that allows enterprises to determine the optimal time to contact users, considering user consent and preferences, to enhance engagement and improve answer rates.

The present invention provides a system and method for optimizing outbound communication by determining the optimal time for enterprises to make calls to users. The solution involves storing trusted businesses associated with user profiles and utilizing a server to manage communication requests. The server sends Rich Communication Service (RCS) messages to users, allowing them to select preferred schedules for receiving calls. By analyzing historical data and employing machine learning models, the system predicts optimal communication times, dynamically adjusts user options, and integrates user preferences into enterprise CRM and dialer systems. This approach enhances user engagement, ensures compliance with user preferences, and increases the likelihood of successful communication.

The technical effect of present disclosure, which outlines a method and a system for determining the optimal time for an enterprise to make outbound calls to a user, is multifaceted. Firstly, the method and the system enhances user engagement by allowing users to select their preferred time for receiving calls, thereby increasing the likelihood of answered calls and improving engagement rates. The method and the system also improves communication efficiency by optimizing the timing of outbound calls, reducing the number of missed or ignored calls, and ensuring that communication efforts are more productive. Additionally, the method and the system provides a personalized user experience by storing user profiles and preferences, leading to higher user satisfaction and trust in the enterprise. The system's ability to dynamically adjust user options based on historical data and user behavior ensures that the communication strategy remains relevant and effective over time. Furthermore, the integration of user-selected schedules into enterprise CRM and dialer systems streamlines the process of scheduling and initiating calls, reducing administrative overhead and potential errors. Lastly, the use of historical data and machine learning models to predict optimal communication times allows enterprises to make informed decisions, enhancing the overall effectiveness of the communication strategies.

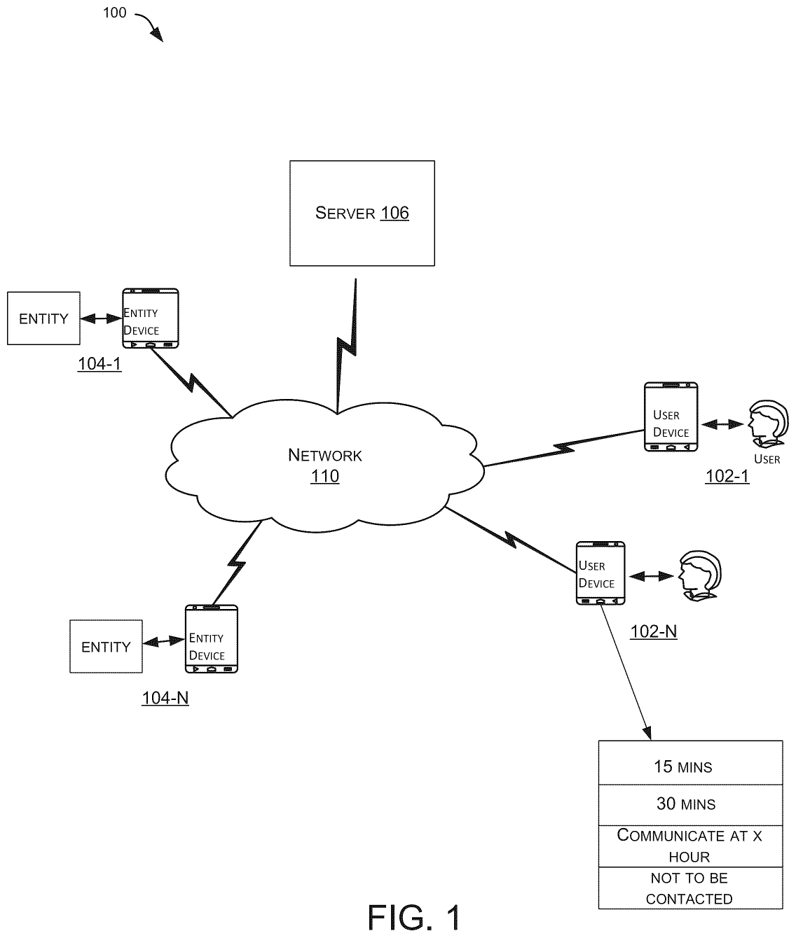

The detailed operation and functional components involved in the system and method have been described in conjunction with FIGS. 1 to 4.

Referring to FIG. 1, the system (100) for optimizing outbound communication is illustrated according to one or more embodiments of the present disclosure. The system (100) may include one or more first computing devices (104) (may be interchangeably referred to entity devices (104-1) to (104-N), which may be collectively referred as (104) associated with an enterprise (104) or an entity (104), configured to initiate an authorization request for initiating communication with a user (102). The system (100) may also include one or more second computing devices (102) (may be interchangeably referred to user devices (102-1) to (102-N), which may be collectively referred to (102)) associated with the user (102), configured to receive the communication from the one or more first computing devices (104).

Further the system (100) may also include a server (106) and a network (110). Further, the embodiments of the present disclosure are described herein considering that the system (100) is implemented as a web application or computer program on a server (106); it may be readily appreciated that the system (100) may also be implemented in a variety of computing systems, such as a laptop computer, a desktop computer, a notebook, a workstation, a network server, a cloud-based environment, and the like. The server (106) may be communicatively coupled to the one or more first computing devices (104) and one or more second computing devices (102) using the network (110).

Further, the network (110) may be a communication network, such as, but not limited to, a packet data switching network such as the internet, a proprietary network, a wireless Global System for Mobile Communications (GSM) network, among others. The network (110) is capable of communicating data to and from the one or more first computing devices (104), the one or more second computing devices (102), and the server (106).

In an embodiment, the server (106) may be communicatively coupled to the one or more second computing devices (102) and includes one or more processors coupled to a memory storing instructions executable by the one or more processors. Herein, the server (106) may be configured to receive the authorization request from the one or more first computing devices (104). The server sends a communication message to the one or more second computing devices (102). The communication message may include options for the user (102) to select a preferred time to communicate with the enterprise (104). The server (106) receives a response from the user (102). The response may include, but not limited to, consent for receiving communication from the enterprise (104) and the preferred time for receiving the communication. Further, the server (106) provides the response to the one or more first computing devices (104) to schedule and initiate the communication from the enterprise based on the received consent and the preferred time. The server (106) may dynamically adjust the options for the user (102) based on the recorded consent and the preferred time for a predetermined period for continuous user engagement . . . .

In one embodiment, the server (106) may also be configured to maintain a repository of trusted entities and utilize the repository to validate authorization requests prior to sending the communication message to the second computing device (102). When a user (102) subscribes to services offered by the entities (104), the information about the entities (104) may added to the repository. The repository may serve as a reference point for validating the legitimacy of authorization requests and ensures that only authorized entities (104) can initiate communication with the users (102). For example, the repository may serve as a centralized database where information about trusted entities is stored. The stored information may include, but not limited to, name of the entity (104), the services provided by the entity (104), and any pertinent authorization credentials. Further, depending on the context and requirements, information about trusted entities (104) between users (102) and entities (104) may be stored on a short-term basis, spanning only a few hours or days, or can be set as permanent arrangements. The information enables the users (102) to tailor preferences based on specific needs, accommodating varying levels of trust and engagement with different entities (104) over time.

In one embodiment, the server (106) may also be configured to determine the user's subscription status to validate active engagement with the enterprise (104) before sending the communication message.

In one embodiment, the options may include any or a combination of a specific callback time, an allowed delay in the communication, and an option for declining the communication.

In one embodiment, the server (106) may be configured to integrate with an enterprise customer relationship management (CRM) system to record and process the preferences of the user for scheduling the communication.

In one embodiment, the server (106) may also be configured to dynamically adjust the timing and frequency associated with the communication based on historical patterns of user engagement and response behavior recorded for the predetermined period.

In one embodiment, the communication message includes at least one of: a rich communication services (RCS), a built-in messaging service associated with the second computing device, a third-party messaging service associated with the second computing device (102), or an enterprise application installed on the second computing device (102)

In one embodiment, the server (106) may also be configured to transmit user consent data to the first computing device (104) for initiating the communication.

In an embodiment, the server (106) may include a mapping mechanism that associates the stored list of trusted entities (104) with a user profile. The user profile may include multiple global phone numbers linked to the user (102). The mapping mechanism may enable the establishment of a connection between the user (102) and the trusted entities (104) that the users (102) are associated with. The mapping mechanism may further involve a set of identifiers assigned to the user profile to enhance identification and tracking. The identifiers may serve as unique markers, facilitating the efficient management and retrieval of information related to the user's interactions with the trusted entities (104). The identifiers may include but not be limited to phone numbers, URLs, or any other kind of identity codes.

In an embodiment, the server (106) may further be configured to send a customized communication message to the second computing device (102) associated with the user (102). The customized communication message may include, but not limited to, various options for the user (102) to select a preferred time for communication and provide consent for communication. In an example, sending the customized message may operates on a dynamic basis, adapting to the specific requirements of each interaction including both overarching customization options and the ability to fine-tune preferences at the level of individual interactions. For example, before initiating a communication session, the system (100) may evaluate contextual factors and user preferences to create a personalized message that reflects the user's overall communication style and integrates specific details relevant to the upcoming interaction, thereby ensuring a personalized and relevant communication experience.

In an embodiment, the server (106) may be configured to send the communication message to the user's second computing device using Rich Communication Services (RCS). The utilization of RCS facilitates the delivery of rich communication messages without necessitating the installation of a dedicated application on the second computing device. The implementation may allow for communication through built-in capabilities of the one or more second computing devices (102), such as, but not limited to, SMS, or leveraging existing Over-The-Top (OTT) platforms eliminating the need for additional installations and ensuring user accessibility. In another example embodiment, the server (106) may be configured to transmit the communication message to the one or more second computing device (102) through an application installed on the one or more second computing device (102). For example, the application that possesses the requisite permissions to intercept incoming calls on the one or more second computing device (102) to ensure a streamlined communication process. In another example embodiment, the server (106) may send the communication message via an enterprise application installed on the one or more second computing device (102), thereby providing flexibility in the communication channel while maintaining enterprise-specific functionalities.

In an embodiment, the server (106) may also be configured to receive a preferred response from the user (102). The preferred response may include consent for the entity (104) to communicate and a preferred time for communication. Further, to ensure timely and convenient communication, the selection of preferred responses may be facilitated through notifications on the one or more second computing device (102) associated with the user (102). For example, the server (106) may be configured to provide different options, as depicted in FIG. 1. A notifications alert to the user (102) about communication requests from the entity (104) and prompt them to provide their preferred response . . . . For example, the server (106) may provide options such as contact after 15 minutes, 30 minutes, communicate at x hour, or not to be contacted, which indicates the user's preferences (preferred response).

In an embodiment, the server (106) may be configured to dynamically adjust a plurality of options based on past user interaction history. The server (106) may personalize the available options by analyzing previous communication patterns and user responses to better align with individual user preferences and behavior. Such adaptive approach enhances the relevance and effectiveness of the communication process. Additionally, users (102) are empowered to specify callback time ranges and time slots for call initiation. The users (102) are empowered to specify callback time ranges and time slots for call initiation, further customizing communication preferences . . . .

The server (106) may be configured to provide the preferred responses to the one or more first computing devices (104) associated with the entity (104). The entity 104 may include necessary information to schedule and initiate outbound communications, ensuring that the communication aligns with the received consent and the user's indicated preferred time. The objective is to ensure that such interactions conform to the received consent from the users (102) and correspond to the timeframes indicated by users (102) as preferred, thus augmenting the probability of user engagement. For example, the server (106) may facilitate the transmission of user consent data back to the entity (104), where the server may be integrated into their existing customer relationship management (CRM) system (or a CRM server) or a dialer. The integration ensures that the enterprise are enabled to access the user preferences and consent information, providing the entity (104) to reconnect with users (102) precisely at the agreed-upon time.

In one embodiment, the server (106) may also be configured to analyze user behavior and optimize the timing of communication using one or more machine learning models.

In an embodiment, the server (106) may also include advanced mechanisms, incorporating machine learning (ML) models and/or artificial intelligence (AI) models to analyze user preferences and behavior patterns. The advanced mechanisms may enable the server (106) to dynamically adjust the frequency and timing of outbound communications, fostering a more personalized approach to engagement, crucial for maximizing effectiveness. Through iterative learning and adaptation, the AI/ML models refine their understanding of user preferences, communication habits, and responsiveness, enhancing the accuracy of predictions regarding optimal communication timing and frequency. Additionally, the user preferred responses may be analyzed, allowing for the suggestion of enhanced user messages may help to improve the possibility of the user providing consent for the call. By engaging the AI/ML models analysis, the server (106) may provide enterprises with actionable insights to tailor communication strategies for individual users (102) or specific demographics. Furthermore, the utilization of the AI/ML models may enable the server (106) to continually adapt and refine the communication strategies in response to real-time feedback and evolving user behaviors.

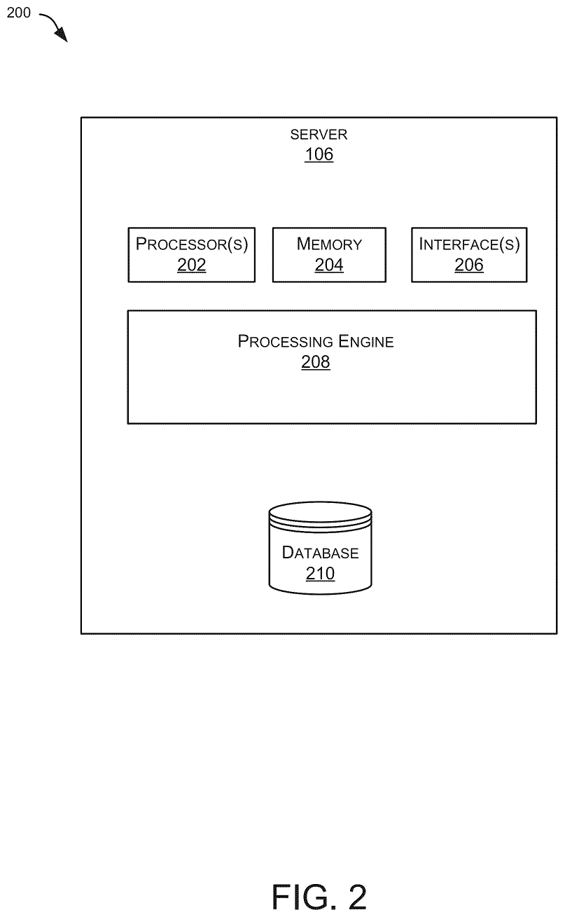

Referring now to FIG. 2, illustrates an exemplary block diagram (200) of the server (106), for example, the server (106) of FIG. 1, in accordance with one or more embodiment of the present disclosure. The server (106) may include one or more processor(s) (202). The one or more processor(s) (202) may be implemented as one or more microprocessors, microcomputers, microcontrollers, digital signal processors, central processing units, logic circuitries, and/or any devices that manipulate data based on operational instructions. Among other capabilities, the one or more processor(s) (202) may also be configured to fetch and execute computer-readable instructions stored in a memory (204) of the server (106). The memory (204) may store one or more computer-readable instructions or routines, which may be fetched and executed to create or share the data units over the network (110). Examples of the memory (204) may include, but not limited to, a non-transitory storage device such as a volatile memory e.g., random access memory (RAM), or a non-volatile memory e.g., erasable programmable read-only memory (EPROM), a flash memory, and the like.

The server (106) may also include an interface(s) (206). Examples of the interface(s) (206) may include, but not limited to interfaces for data input and output devices, referred to as I/O devices, storage devices, wired or wireless communication module and adaptors for remote data communication and the like. The interface(s) (206) may facilitate communication of server (106). The interface(s) (206) may also provide a communication pathway for one or more components of the server (106). Examples of such components include, but are not limited to, a processing engine(s) (208) and a database (210).

The processing engine(s) (208) may be implemented as a combination of hardware and programming (for example, programmable instructions) to implement one or more functionalities of the processing engine(s) (208). In the examples described herein, such combinations of hardware and programming may be implemented in several different ways such as processor-executable instructions stored on a non-transitory machine-readable storage medium. The hardware for the processing engine(s) (208) may include a processing resource (for example, one or more processors), to execute such instructions. In the present examples, the machine-readable storage medium may store instructions that, when executed by the processing resource, implement the processing engine(s) (208). In such examples, the server (106) may include the machine-readable storage medium storing the instructions and the processing resource to execute the instructions, or the machine-readable storage medium may be separate but accessible to server (106) and the processing resource. In other examples, the processing engine(s) (208) may be implemented by electronic circuitry. The database (210) may include data that is either stored or generated as a result of functionalities implemented by any of the components of the processing engine(s) (208) or the server (106).

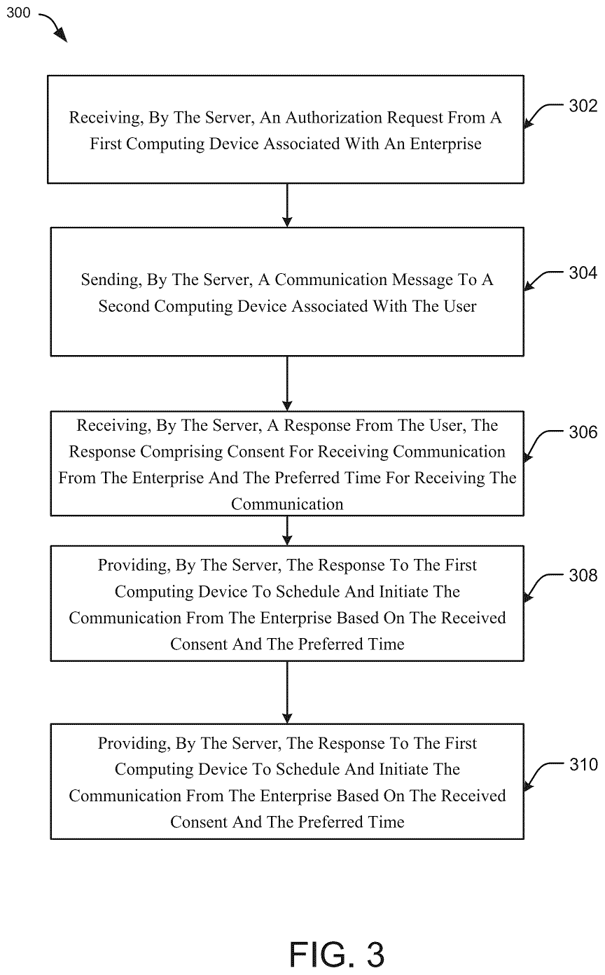

Referring to FIG. 3, a flow diagram of a method (300) optimizing the answer rate of outbound communication is disclosed, in accordance with one or more embodiments of the present disclosure.

At step (302), the method (300) may include receiving, by the server (106), an authorization request from the first computing device (104) associated with an enterprise. Herein, the authorization request may be for initiating communication with a user (102).

At step (304), the method (300) may include sending, by the server (106), a communication message to a second computing device (102) associated with the user (102). The communication message may include options for the user (102) to select a preferred time to communicate with the enterprise (104).

At step (306), the method (300) may include receiving, by the server (106), a response from the user (102). Herein, the response may include consent for receiving communication from the enterprise (104) and the preferred time for receiving the communication.

At step (308), the method (300) may include providing, by the server (106), the response to the first computing device (104) to schedule and initiate the communication from the enterprise (104) based on the received consent and the preferred time.

At step (310), the method (300) may include dynamically adjusting the options for the user (102) based on the recorded consent and the preferred time for a predetermined period for continuous user engagement.

It should also be noted that the steps for executing the method (300) described herein are not limited to the specific steps outlined above. The method may be implemented in various other ways, and the steps may be reordered, combined, or modified without departing from the scope and spirit of the invention. The examples provided are for illustrative purposes only and are not intended to limit the invention to the specific embodiments disclosed. Those skilled in the art will recognize that various modifications and adaptations can be made to the method without departing from the broader inventive concepts disclosed herein.

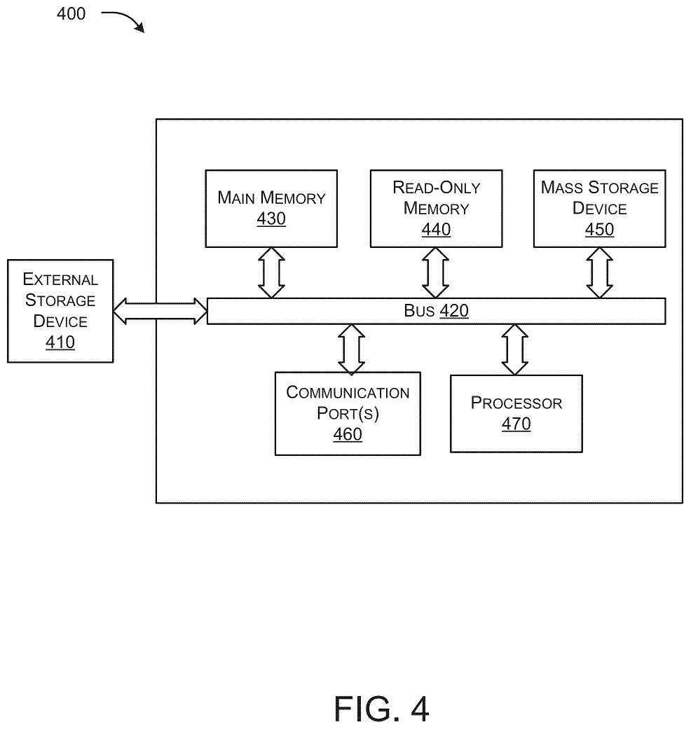

FIG. 4 illustrates a block diagram for an exemplary computer system (400), in accordance with one or more embodiments of the present disclosure. In an example embodiment, the server (106) of FIG. 1 or the first computing device or the second computing device may be implemented as the computer system (400).

Referring to FIG. 4, the computer system (400) may include an external storage device (410), a bus (420), a main memory (430), a read only memory (440), a mass storage device (450), communication port (460), and a processor (470). A person skilled in the art will appreciate that the computer system (400) may include more than one processor and communication ports. The processor (470) may include various engines associated with embodiments of the present disclosure. The communication port (460) may be any of an RS-232 port for use with a modem-based dialup connection, a 10/100 Ethernet port, a Gigabit or 10 Gigabit port using copper or fiber, a serial port, a parallel port, or other existing or future ports. The communication port (460) may be chosen depending on a network, such a Local Area Network (LAN), Wide Area Network (WAN), or any network to which the computer system (400) connects.

In an embodiment, the memory (430) may be a Random Access Memory (RAM), or any other dynamic storage device commonly known in the art. The read only memory (440) may be any static storage device(s) e.g., but not limited to, a Programmable Read Only Memory (PROM) chips for storing static information e.g., start-up or BIOS instructions for the processor (470). The mass storage (460) may be any current or future mass storage solution, which may be used to store information and/or instructions. Exemplary mass storage solutions may include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), one or more optical discs, Redundant Array of Independent Disks (RAID) storage, e.g. an array of disks (e.g., SATA arrays).

In an embodiment, the bus (420) may be communicatively coupled to the processor (470) with the other memory, storage, and communication blocks. The bus (420) may be, e.g., a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects the processor (470) to software system.

In another embodiment, operator and administrative interfaces, e.g., a display, keyboard, and a cursor control device, may also be coupled to the bus (420) to support direct operator interaction with computer system. Other operator and administrative interfaces can be provided through network connections connected through the communication port (460). External storage device (410) may be any kind of external hard-drives, floppy drives, Compact Disc-Read Only Memory (CD-ROM), Compact Disc-Re-Writable (CD-RW), Digital Video Disk-Read Only Memory (DVD-ROM) or an isolated remote storage device or operatively connected to a remote computing device such as a computer, cloud server, or a mobile computing device. Components described above are meant only to exemplify various possibilities. In no way should the aforementioned exemplary computer system limit the scope of the present disclosure.

In interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions or examples, which are comprised to enable a person having ordinary skill in the art to make and use the invention when combined with information and knowledge available to those having ordinary skill in the art.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications, and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

### ADVANTAGES OF THE PRESENT INVENTION

The present disclosure provides a reliable system and method for users to specify their preferred time for communication, leading to increased user engagement and satisfaction.

The present disclosure streamlines the communication process by considering user preferences and subscription status, thereby reducing the likelihood of unproductive or unwanted communications.

The present disclosure provides predictive analysis of optimal communication timing based on historical patterns and increases the chances of reaching users when they are most likely to be available.

The present disclosure dynamically adjusts the frequency and timing of outbound calls based on user preferences and behavior.

The present disclosure provides a personalized and user-friendly experience, making communication more intuitive for users.

1. A system for optimizing outbound communication, comprising:
one or more first computing devices associated with an enterprise, configured to initiate an authorization request for initiating communication with a user;
one or more second computing devices associated with the user, configured to receive the communication from the one or more first computing devices;
a server communicatively coupled to the one or more second computing devices and comprising one or more processors coupled to a memory storing instructions executable by the one or more processors, wherein the server is configured to:
receive the authorization request from the one or more first computing devices;
send a communication message to the one or more second computing devices, the communication message comprising options for the user to select a preferred time to communicate with the enterprise;
receive a response from the user, the response comprising consent for receiving communication from the enterprise and the preferred time for receiving the communication;
provide the response to the one or more first computing devices to schedule and initiate the communication from the enterprise based on the received consent and the preferred time; and
dynamically adjust the options for the user based on the recorded consent and the preferred time for a predetermined period for continuous user engagement.

2. The system as claimed in claim 1, wherein the server is configured to maintain a repository of trusted entities and utilize the repository to validate authorization requests prior to sending the communication message to the second computing device.

3. The system as claimed in claim 1, wherein the server is configured to determine the user's subscription status to validate active engagement with the enterprise before sending the communication message.

4. The system as claimed in claim 1, wherein the options comprise any or a combination of: a specific callback time, an allowed delay in the communication, and an option for declining the communication.

5. The system as claimed in claim 1, wherein the server is configured to integrate with an enterprise customer relationship management system to record and process the preferences of the user for scheduling the communication.

6. The system as claimed in claim 1, wherein the server is configured to dynamically adjusts the timing and frequency associated with the communication based on historical patterns of user engagement and response behavior recorded for the predetermined period.

7. The system as claimed in claim 1, wherein the server is configured to analyze user behavior and optimize the timing of communication using one or more machine learning models.

8. The system as claimed in claim 1, wherein the communication message comprises at least one of: a rich communication services, a third-party messaging service associated with the second computing device, or an enterprise application installed on the second computing device.

9. The system as claimed in claim 1, wherein the server is configured to transmit user consent data to the one or more first computing device for initiating the communication.

10. A method for optimizing the answer rate of outbound communication, the method comprising:
receiving, by a server, an authorization request from a first computing device associated with an enterprise, wherein the authorization request for initiating communication with a user;
sending, by the server, a communication message to a second computing device associated with the user, the communication message comprising options for the user to select a preferred time to communicate with the enterprise;
receiving, by the server, a response from the user, the response comprising consent for receiving communication from the enterprise and the preferred time for receiving the communication;
providing, by the server, the response to the first computing device to schedule and initiate the communication from the enterprise based on the received consent and the preferred time; and
dynamically adjusting, by the server, the options for the user based on the recorded consent and the preferred time for a predetermined period for continuous user engagement.
